(19) United States
(12) Patent Application Publication
(10) Pub. No.: US 2011/0219375 A1
(43) Pub. Date: Sep. 8, 2011

(54) ENHANCED WORK-FLOW MODEL CAPABLE OF HANDLING EXCEPTIONS

(75) Inventors: Hung-Yang Chang, Scarsdale, NY (US); Frederick Yung-Fung Wu, Greenwich, CT (US); Liangzhao Zeng, Mohegan Lake, NY (US)

(73) Assignee: INTERNATIONAL BUSINESS MACHINES CORPORATION, Armonk, NY (US)

(21) Appl. No.: 12/717,729

(22) Filed: Mar. 4, 2010

(51) Int. Cl. G06F 9/46; G06N 5/00; G06F 17/00

(52) U.S. Cl. 718/100; 706/45

(57) ABSTRACT

A system and method for augmenting a work-flow model to handle all expected and unexpected exceptions during run-time. The system includes an Exception Handling Knowledge Base (EHKB), a Work-flow Manager for managing the execution of the work-flow model and automatically adding exception transitions from the EHKB to the model except those forbidden, and a Work-flow Monitor for monitoring the model execution. The Monitor generating alerts to a business manager when the exceptions are encountered. At build-time, a process analyst could define a process schema in a Process Schema Repository, specify a forbidden exception or modify a schema to handle an exception based on guidance from the EHKB. At run-time, a user may initiate a forbidden exception with approval from the business manager.

### FIELD OF THE INVENTION

The invention relates generally to process work-flows, and more particularly, to a system and method for augmenting a work-flow model for handling all exception paths at run-time.

### BACKGROUND

Work-flow management systems are becoming widely used for specifying and controlling the way in which process operations are conducted in enterprises and in software applications. Business managers and analysts design process models based on experience and simulations. These models are used either for documentation and training of new employees, or as input to semi-automated tools for developing work-flow applications that implement the operation processes.

A major deficiency with the resulting work-flow applications generated with this method is their inflexibility. A resulting process model does not include all possible execution sequences for two reasons. First, it is not practical for a business analyst to imagine all possible operation scenarios that might occur, and the model therefore does not allow for certain execution paths that may someday become necessary. Second, the analyst wants to avoid making the process model too complex by designing all possible execution paths and including them in the model.

Any operation process has a set of “normal” execution paths, i.e., the sequences of actions that behave as desired and anticipated by the analyst. A process also has “exceptions,” which can be of two types. Expected exceptions are those of which the analyst is aware. Unexpected exceptions are those that the analyst did not think about during the process design. Including all expected exception paths would make a process model so complex that it becomes very difficult to understand and leads to an extremely costly and complex software implementation.

On the other hand, modeling a process without consideration of exceptions usually results in an implementation that is too inflexible to handle many rare, but real situations. In those situations, human intervention is required, and the user must frequently find a workaround that circumvents the work-flow solution. However, when the user works outside of the work-flow solution, any monitoring or alert system that tracks the work-flow solution may not record the exception. This practice can therefore lead to a loss of control of the process without any notification to the process management.

From the foregoing, it is appreciated that there exists a need for a system and method for improving a work-flow modeling system to handle all possible exception paths that are both expected or unexpected by the process analyst.

### SUMMARY OF THE INVENTION

The invention is directed to a system and method for augmenting a work-flow model for handling all expected and unexpected exception paths during run-time. The work-flow model is generated using a traditional work-flow modeling tool. For purposes of illustration, it is assumed that the work-flow is modeled as a state machine, and that execution paths are defined by transitions between states. The system includes an Exception Handling Knowledge Base, a Work-flow Manager, a Work-flow Monitor, and a Process Schema Repository. The Exception Handling Knowledge Base contains details for handling the exceptions to the work-flow process. The Work-flow Manager allows a process analyst to define work-flow schema and save them into the Process Schema Repository. The Work-flow Manager also manages the execution of the work-flow model at run-time. The Work-flow Monitor, on the other hand, monitors for the work-flow exceptions at run-time and logs the execution of the work-flow transitions in a data repository.

At build-time, the Work-flow Manager allows a process analyst to modify a work-flow schema in the Process Schema Repository for handling an exception based on guidance in the Exception Handling Knowledge Base, or to specify an exception that is not permitted in the work-flow, i.e., a forbidden exception. Before the execution of the work-flow model starts, the Work-flow Manager automatically adds the exception transitions from the Exception Handling Knowledge Base to the model except those that have been identified as forbidden by the analyst. The added exceptions include those that are both expected and unexpected by the analyst. The expected exceptions correspond to input-output connection paths in the model. The unexpected exceptions correspond to the paths between the inputs and outputs of the work-flow model that were not connected when the process modeling tool generated the model.

During the execution of the work-flow model, the Work-flow Manager manages the process instances and allows the analyst to interact with the process instances as needed. There are three modes of operation while the model is being executed: normal mode, exception mode, and requested exception mode. In the normal operation mode, only the transitions explicitly defined in the Process Schema Repository are executed by the modeling system. In the exception mode, the system executes any exception transitions other than those forbidden and specified in the Exception Handling Knowledge Base. In the requested exception mode, a forbidden transition can also be executed if a request is submitted by the operational user and approval is granted by a business manager. The process transitions in the normal mode are automatically executed by the Work-flow Manager while the exception transactions in the exception mode are initiated by the process analyst or a user of the model. If the analyst or user wants to execute a forbidden exception transition, the analyst or user needs to request and receive an approval from a business manager.

The process modeling system of the invention further includes an Execution Log Repository for storing data during the execution of the work-flow model. The Work-flow Monitor generates and stores an exception execution log into the Execution Log Repository whenever an exception transition is executed. An Exception Handling Knowledge Manager periodically generates reports on the execution of the exception transitions from statistics gathered in the Execution Log Repository. In addition, the Work-flow Monitor uses the execution log statistics to normalize the exception transitions that occur frequently and those that represent important events in the work-flow.

If there is a forbidden exception transition that has frequently been initiated by the users, then the Exception Handling Knowledge Manager would alert the process analyst about this particular exception. The analyst might decide to enable the forbidden exception so that it will be automatically handled by the model in the future. The analyst might choose to have the rules for the forbidden exception, as stored in the Exception Handling Knowledge Base, executed automatically when the exception is encountered again. Alternatively, the analyst might change the process schema for the forbidden exception, as defined in the Process Schema Repository, to make it a normal process transition rather than an exception. The rules for the exception transitions are typically in the ECA format where E indicates the exception event that may trigger the transition, C refers to the condition that determines whether to execute the transition and A is the action that is performed if the condition is met.

The system of the invention further has a user interface for allowing users to interact with the Work-flow Manager in any of the three operation modes. In the normal mode, only normal transition paths are enabled. If the user chooses to operate in exception mode, then he can execute any non-forbidden transition. Finally, in the requested exception mode, the user may submit a request to execute a forbidden transition. The user interface could then route the request to a business manager for approval or rejection. The system also includes an Exception Handling Knowledge Manager for generating reports on the execution of the exception transitions from the data in the Process Execution Repository and alerting a an analyst on frequently-initiated exceptions.

In another aspect of the invention, a computer-implemented method for enhancing a work-flow model to handle exceptions is described. The method includes automatically adding all unexpected exception transitions to a work-flow model that has been generated using a traditional process modeling tool. The model has normal transitions in the process, model inputs and model outputs. The unexpected exception transitions correspond to the paths between the inputs and outputs that have not been connected during the model generation. The invention further monitors the execution of the work-flow model to detect the exception transitions and generates alerts to a business manager about the exceptions.

During the model build-time, the method of the invention allows a process analyst to specify certain exceptions as forbidden in the Exception Handling Knowledge Base. In the normal operation mode at run-time, only the transition paths explicitly defined in the Process Schema Repository are executed. In the exception mode, any transactions would be executed except those forbidden in the Exception Handling Knowledge Base. In the requested exception mode, the user may submit a request to execute a forbidden transition. The user interface will then route the request to a business manager for approval or rejection.

In yet another aspect of the invention, a computer program product for enhancing a work-flow model to handle exceptions is described. The product includes a computer usable storage medium on which readable program code is stored. The code is operable to automatically add all unexpected exception transitions to a work-flow model that has been generated using a traditional work-flow modeling tool, monitors the execution of the work-flow model to detect the exception transitions and generates alerts to a business manager about the exceptions.

The details of the present invention, both as to its structure and operation, are described below in the Detailed Description section in reference to the accompanying drawings, in which like reference numerals refer to like parts. This Summary is intended to identify key features of the claimed subject matter, but it is not intended to be used to limit the scope of the claimed subject matter.

### BRIEF DESCRIPTION OF THE DRAWINGS

FIG. 1 is a block diagram illustrating a typical work-flow model that may be generated using a state machine-based work-flow modeling tool.

FIG. 2 is a block diagram illustrating the work-flow model with all paths between the model inputs and outputs connected, according to aspects of the invention.

FIG. 3 is a block diagram showing a system for augmenting a work-flow model to handle all expected and unexpected exceptions, according to aspects of the invention.

FIG. 4 is a block diagram illustrating an example of a work-flow exception transition that is added to the work-flow model, according to aspects of the invention.

FIG. 5 is a flow chart representing an exemplary embodiment of the process for augmenting a work-flow model to handle process exceptions, according to aspects of the invention.

FIG. 6 is a flow chart representing an exemplary embodiment of the operations performed by the Work-flow Manager at run-time, according to aspects of the invention.

FIG. 7 is a flow chart representing an exemplary embodiment of the operations performed by the Exception Handling Knowledge Manager at run-time, according to aspects of the invention.

### DETAILED DESCRIPTION OF THE INVENTION

The invention relates generally to a system and method for enhancing a work-flow model for handling all exceptions to the work-flow. More specifically, the invention augments the work-flow model to add all unexpected exception transitions and automatically executes the transition rules for the exceptions unless an exception is forbidden by a process analyst. In case of a forbidden exception, the invention alerts the user who could still initiate the exception with the approval of a business manager at the respective enterprise.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

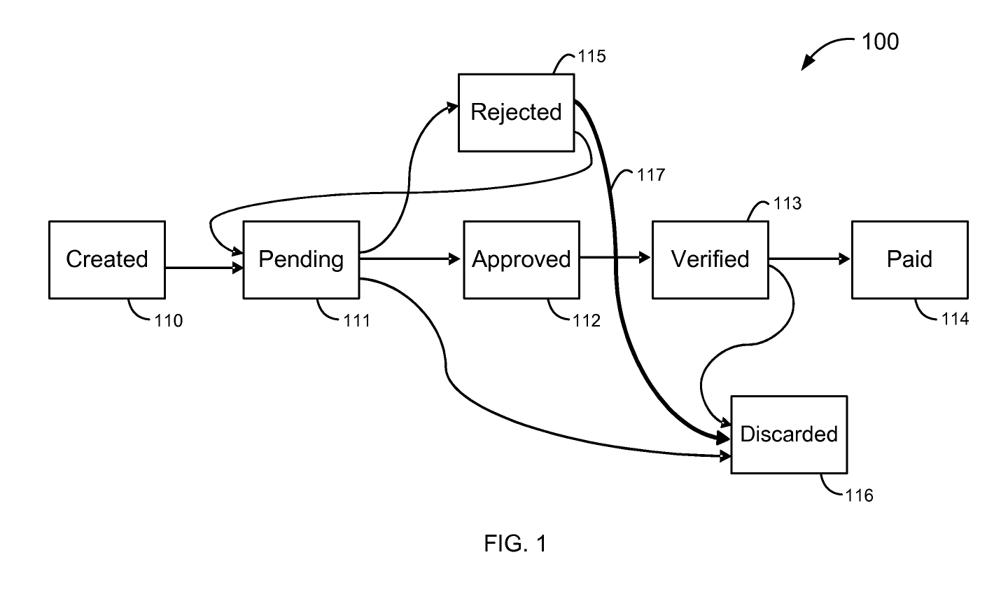

FIG. 1 is a block diagram showing a typical state-machine work-flow model 100 that represents a document or artifact that is the subject of the work-flow. The artifact lifecycle is described by the state machine, in which a process analyst defines the states 110 through 116 of the artifact and draws transitions to represent all the normal lifecycle paths. The identified transitions between the states 110-116, such as the transition 117 between the states 115 and 116, correspond to the normal lifecycle transition paths in the work-flow. The model 100 might be created using a traditional state machine modeling tool such as Rational Software Architect, or a traditional activity-based process modeling tool such as WebSphere Business Modeler. Both the Rational Software Architect and the WebSphere Business Modeler are products of International Business Machines Corporation of Armonk, N.Y.

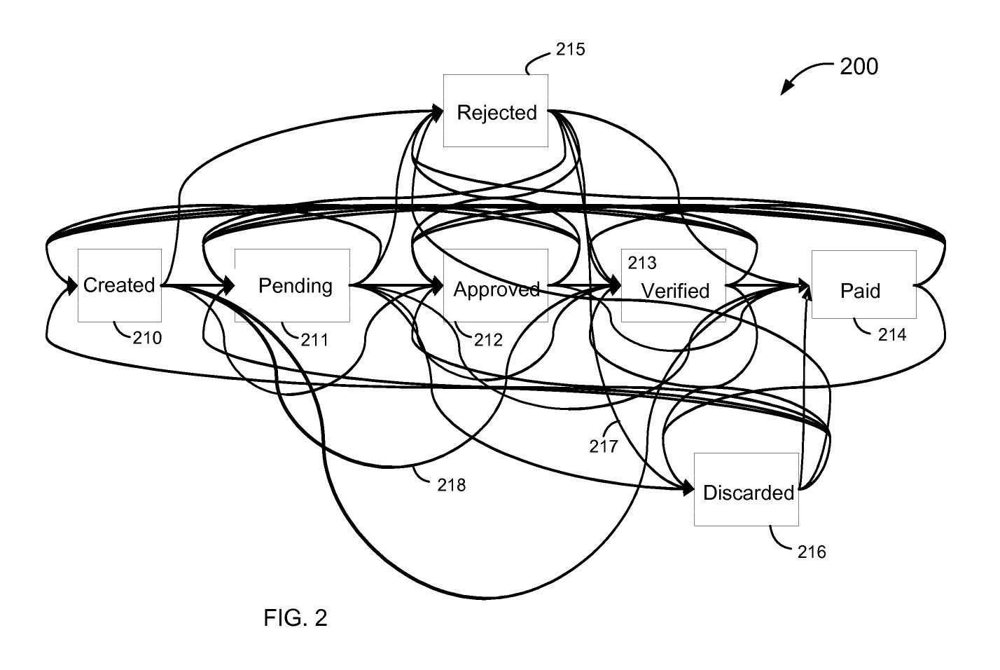

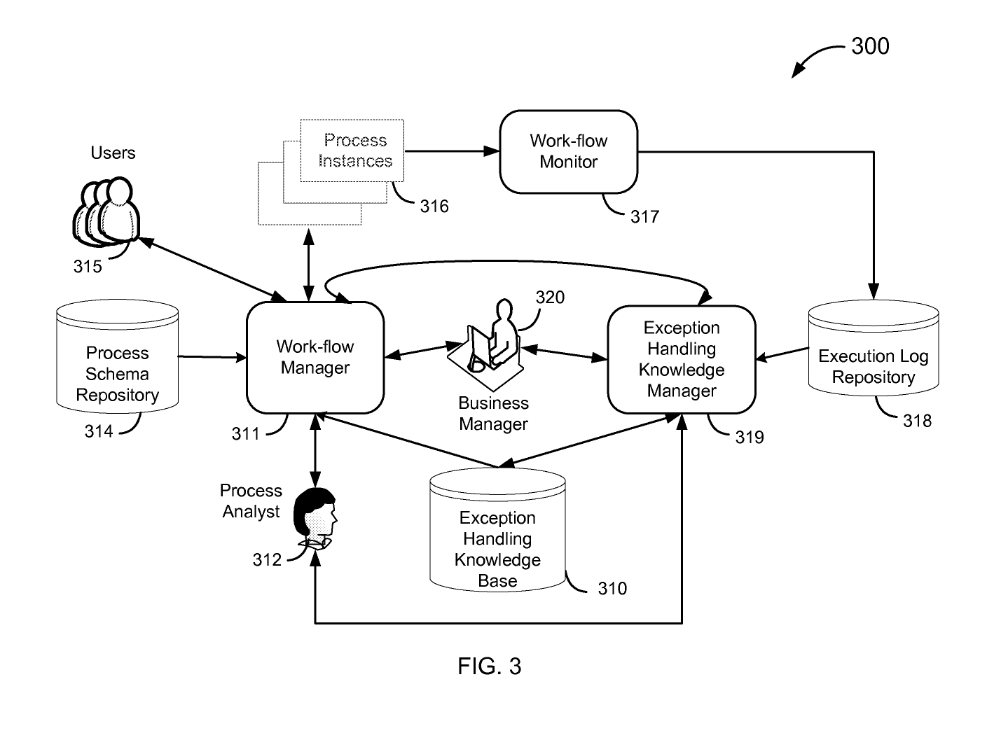

FIG. 2 illustrates a model 200 of the same work-flow but with the additional transition paths between all previously unconnected inputs and outputs of the states 210 through 216 of the model 200. The additional transitions, such as the exception transition 218, correspond to the exceptions in the work-flow and are automatically added to the model 200 by the system and method of the invention. The resulting fully connected state machine model 200 appears very complex, and is not intended to be displayed to the users. The system and method of the invention associates with each automatically added exception transition an action that generates an exception event. These exception events are recorded by a Work-flow Monitor component of the system which is responsible for monitoring the operation of the process. Further details on the Work-flow Monitor component are described below in reference to FIGS. 3 and 5-6.

Upon receipt of such events, there is a variety of actions that the Work-flow Monitor component can take. One option is simply to record the events and make their statistics available in reports. Another option is to immediately alert certain managers who are responsible for the business operations. In between, there are many possibilities, such as accumulating these events until some threshold quantity has been received, before alerting a manager.

The advantage of these options is that they enable operations personnel to violate the normal, planned process when exceptional situations arise, without resorting to workarounds outside the work-flow solution. When the workarounds are used, the record of what was done is frequently lost. With the modeling system and method of the invention, process exceptions are handled within the system and are automatically recorded. At the same time, depending on how the work-flow monitoring is configured, appropriate management attention can be brought to bear when an exception occurs.

When the state machine model is being created, it may be possible for the process analyst to identify certain transitions that should never be permitted. A variation of this exemplary embodiment allows the analyst to specify that certain transitions are forbidden in the work-flow, so that when the modeling tool automatically adds exception transitions, it does not add those that are forbidden. This feature allows the analyst to constrain the range of allowable exceptions, without explicitly having to permit all allowable exceptions, as it is very difficult for an analyst to imagine all exception situations in advance.

FIG. 3 is a block diagram showing the architecture of an exemplary embodiment of a system 300 for augmenting a work-flow model to handle expected and unexpected exceptions, in accordance with aspects of the invention. The system 300 includes a Work-flow Manager 311 for managing the execution of the work-flow model in the form of work-flow instances 316 and allowing the users 315 to interact with the process instances 316 at run-time. The Work-flow Manager 311 also communicates with the Process Schema Repository 314 which contains the definitions of the process transitions and the work-flow actions that correspond to each transition.

The work-flow system 300 further has a Work-flow Monitor 317 that monitors the execution of the work-flow instances 316 at run-time and records execution data in an Execution Log Repository 318. Whenever an exception transition is processed by one of the process instances 316, the Work-flow Monitor 317 generates an execution log and stores the log into the Execution Log Repository 318. The execution log preferably includes a Process Schema ID that identifies the applicable process schema in the Process Schema Repository 314, a Process Instance ID that identifies a process instance 316 that is executed the exception transition, and an Exception Type. The Exception Type may be of “normal”, “rule-enabled” or “forbidden”. The preferred log also includes a Requester ID that indicates the requester of the exception, an Approver ID indicating the approver of the request, as well as a Transition Source and a Transition Target. The Transition Source and Transition Target respectively identify the source state and target state in the work-flow model.

Over time, the statistics gathered in the Execution Log Repository 318 concerning the execution of the exception transitions may be used to normalize certain transitions if they occur frequently or if they represent important situations in the work-flow.

An Exception Handling Knowledge Base 310 is provided in the system 300 that contains the rules for handling each exception as defined by a process analyst 312. At build-time, the Work-flow Manager 311 provides an interface for the process analyst 312 to design work-flow schema and save them into the Process Schema Repository 314. The exception rules might be defined using the ECA format, where E indicates the exception event that may trigger the transition, C represents the condition that determines whether the transition is executed and A is the action that is performed if the condition is met.

Furthermore, at build-time the Work-flow Manager 311 accesses the Exception Handling Knowledge Base 310 to provide the analyst 312 with guidance on modifying the process schema to handle exceptions as part of the future regular operation processes. The process analyst 312 might also specify those exceptions that are not permitted during the execution of the model. These exceptions are referred to as the “forbidden” exceptions and stored in the Exception Handling Knowledge Base 310 at build-time. An important task of the Work-flow Manager 311 is to automatically add all exception transitions in the Exception Handling Knowledge Base 310, except those forbidden, to the work-flow model at build-time.

At run-time, there are three modes of operation for the process instances 316: normal mode, exception mode, and requested exception mode. In the normal mode, only the process transitions and actions explicitly defined in the Process Schema Repository 314 are performed by the process instances 316. In the exception mode, any transitions and actions associated with the exceptions except those forbidden in the Exception Handling Knowledge Base 310 are performed by the process instances 316. In the requested exception mode, a user 315 might manually initiate a forbidden exception transition. The user 315 preferably sends a request to a business manager 320 for approval to initiate the forbidden exception transition. If the manager 320 approves, then the transition for the forbidden exception is enabled.

An Exception Handling Knowledge Manager 319 is provided in the exemplary embodiments of the invention for managing data in the Exception Handling Knowledge Base 310, interfacing with the Work-flow Manager 311, and communicating with the process analyst 312 and the business manager 320. Periodically, the Exception Handling Knowledge Manager 319 processes the execution logs in the Execution Log Repository 318 to generate reports on the execution of the exception transitions by the system 300. An example of the reports created by the Exception Handling Knowledge Manager 319 is shown in Table 1.

TABLE 1

| | Pending-> | Pending-> | Approved-> | Approved-> |
|---|---|---|---|---|
| Date | Verified | Paid | Rejected | Paid |
| 2008 Sep. 25 | 48 | 3 | 0 | 2 |
| 2008 Sep. 26 | 30 | 4 | 2 | 1 |
| 2008 Sep. 27 | 28 | 3 | 1 | 2 |
| 2008 Sep. 28 | 53 | 0 | 2 | 0 |

The Exception Handling Knowledge Manager 319 preferably generates an alert to the process analyst 312 if it detects from the data in the Execution Log Repository 318 that an exception transition that has been frequently initiated by the users 315. The process analyst 312 then can make a decision whether this exception transition should be automatically enabled by having the rules for the exception transition, as defined in the Exception Handling Knowledge Base 310, executed when the same exception is encountered in the future. Alternatively, the process analyst 312 may change the process schema for this exception in the Process Schema Repository 314 to make it a normal process transition rather than an exception.

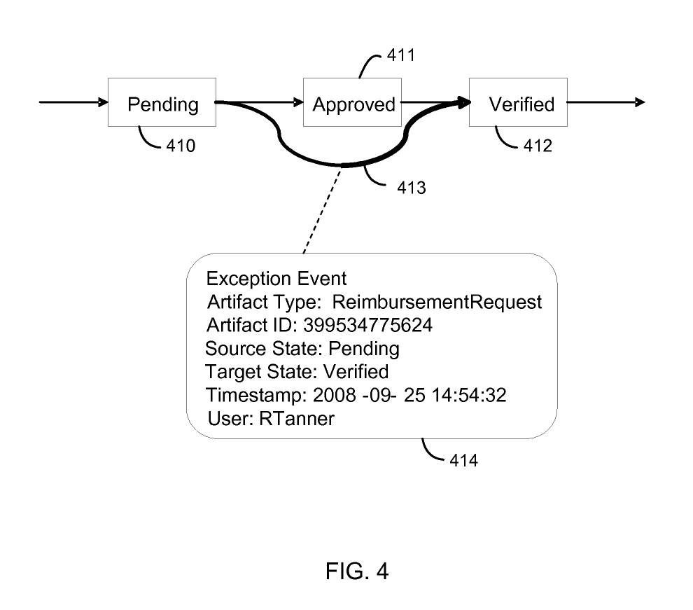

FIG. 4 illustrates an example of the exception transitions in the work-flow model. In a normal course of execution of the work-flow model, a work-flow transaction would go from the pending state 410 to the approved state 411, and then the verified state 412. An exception 414 to the work-flow allows a transaction to bypass the approved state 411, as represented by the transition flow 413 between the pending state 410 and the verified state 412. The exemplary details pertaining to the exception transition 413 are illustrated in block 414 and include an artifact type, an artifact ID, the source and target process states, a time stamp and the user involved in this transaction.

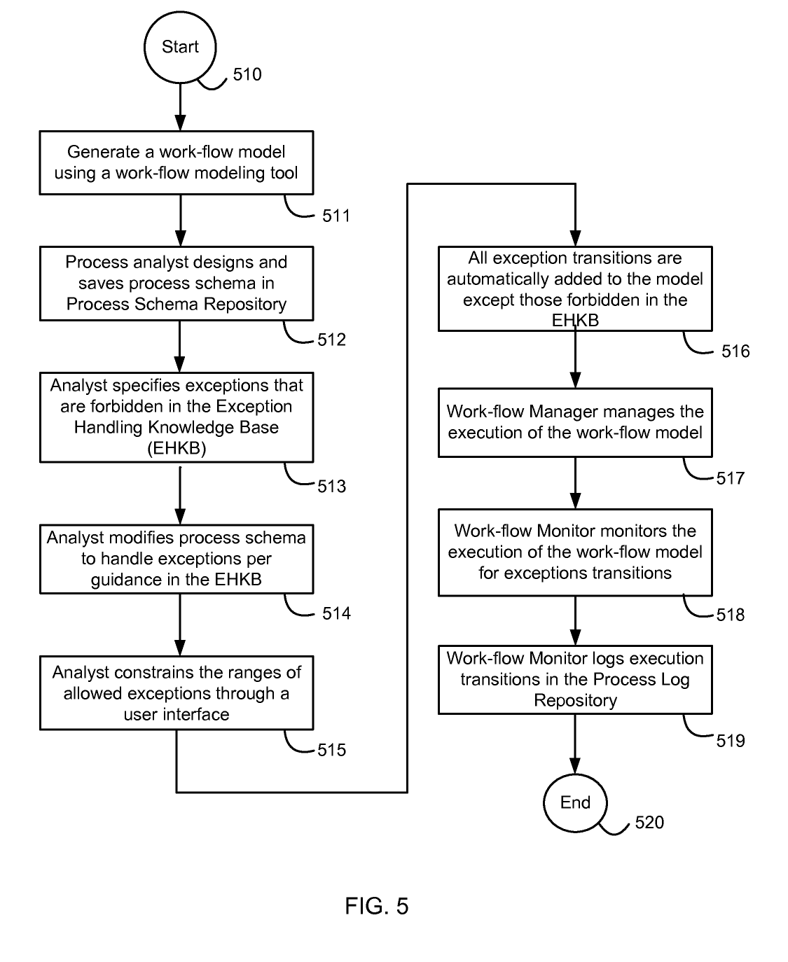

FIG. 5 is a flow chart representing an exemplary method for augmenting a work-flow model to handle exceptions according to aspects of the inventions. The process starts at block 510. At block 511, the work-flow model is created during build-time using a traditional work-flow modeling tool such as the Rational Software Architect or the WebSphere Business Modeler from IBM Corporation of Armonk, N.Y. At block 512, a process analyst designs the process schema for the transitions in the model and saves them in the Process Schema Repository 314. The analyst identifies certain exceptions that are not permitted in the process at block 513. The forbidden exceptions are stored in the Exception Handling Knowledge Base 310. At block 514, the analyst might modify a process schema in the Process Schema Repository 314 to handle an exception based on guidance provided in the Exception Handling Knowledge Base 310. The Process Schema Repository 314 and the Exception Handling Knowledge Base 310 have been described previously in reference to FIG. 3

At block 515, the analyst might further specify certain constraints on the range of allowable exceptions, without explicitly having to permit all allowable exceptions. This is useful because it is practically difficult for the analyst to imagine all exception situations in advance. Although the tasks in blocks 512 through 515 are shown in an exemplary sequence in FIG. 5, they might be arranged in other sequences in alternate embodiments of the invention.

At block 516 and still during build-time, the exception transitions are automatically added to the work-flow model except those that were identified as forbidden in the Exception Handling Knowledge Base 310. During run-time and at block 517, the Work-flow Manager 311, which has been described in reference to FIG. 3, starts managing the execution of the work-flow model. Concurrently, the Work-flow Monitor 317 monitors the execution of the model for exception transitions at block 518. The Work-flow Monitor 317 also logs the execution of the process transitions in the Process Log Repository at block 519. The Work-flow Monitor 317 and the Process Log Repository were described above in reference to FIG. 3. The method for augmenting the work-flow model ends at block 520.

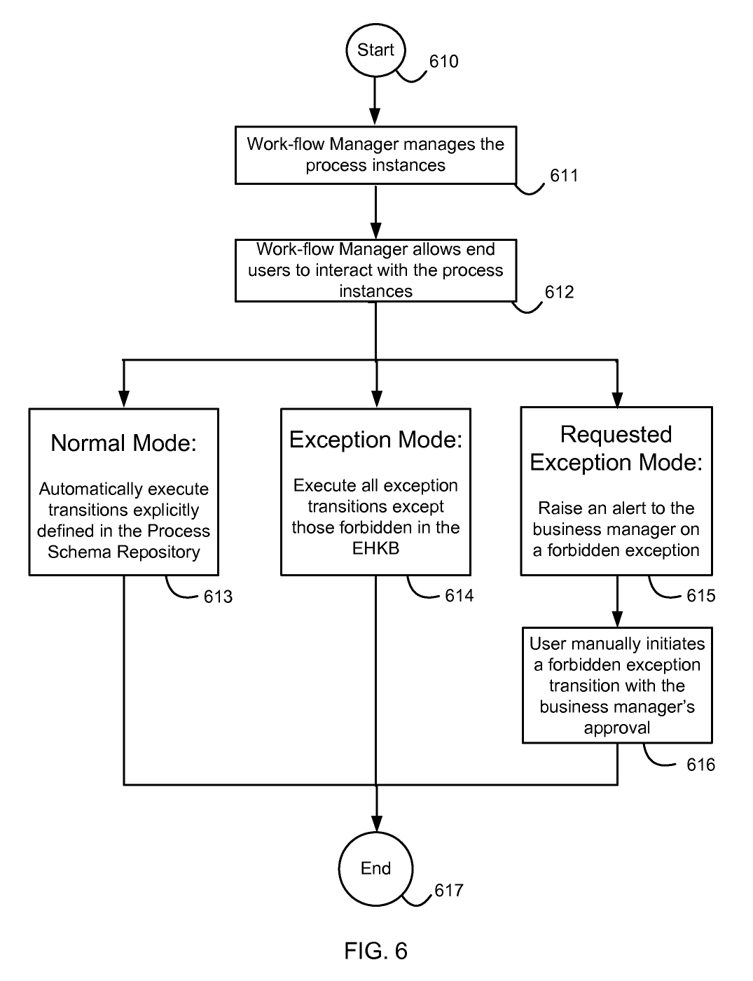

FIG. 6 is a flow chart representing the operations performed by an exemplary embodiment of the Work-flow Manager 311. The operation of the Work-flow Manager 311 begins at block 610. A main task of the Work-flow Manager 311 is to supervise the execution of the process instances in the system, as shown by block 611. At block 612, the Work-flow Manager 311 allows end users of the work-flow model to interact with the process instances. While a process instance is running, there are three modes of operation: normal mode, exception mode, and requested exception mode. The normal mode is represented by block 613 in which only the process transitions explicitly defined in the Process Schema Repository 314 are executed by the process instances. In the exception mode, at block 614, all exception transitions in the model may be executed, except those that are forbidden and identified in the Exception Handling Knowledge Base 310.

When a forbidden exception is encountered by the process instances, the Work-flow Manager 311 notifies a user who could in turn request the business manager for approval to initiate the forbidden exception, as shown at block 615. If the business manager approves the request, then the user could manually initiate the forbidden exception transition at block 616. The operations performed by the Work-flow Manager 311 end at block 617.

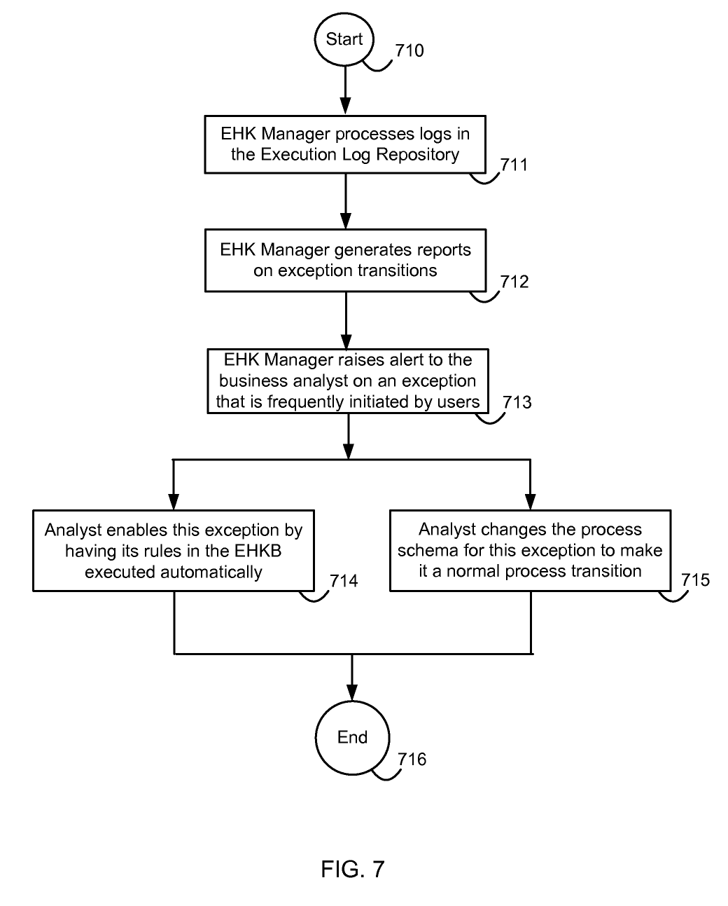

FIG. 7 is a flow chart representing the operations performed by the Exception Handling Knowledge Manager 319 in an exemplary embodiment of the invention. The operations of the Exception Handling Knowledge Manager 319 start at block 710. At block 711, the Exception Handling Knowledge Manager 319 processes the execution logs in the Execution Log Repository 318 that have been recorded by the Work-flow Monitor 317. Using the execution logs, the Exception Handling Knowledge Manager 319 generates reports on the execution of the exception transitions by the process instances at block 712. An example of the reports compiled by the Exception Handling Knowledge Manager 319 was previously shown in Table 1.

Whenever the Exception Handling Knowledge Manager 319 identifies an exceptional transition that has frequently been initiated by the users, it raises an alert to a process analyst, at block 713. At this point, the process analyst has two options to have this exception transition automatically enabled in the future. The analyst may decide to have the rules for the exception, as defined in the Exception Handling Knowledge Base 310, executed automatically, at block 714. Alternatively, the analyst may change the work-flow schema for the exception, as defined in the Process Schema Repository 314, to make the exception transition a normal transition, at block 715. The operational process of the Exception Handling Knowledge Manager 319 ends at block 716.

The subject matter described above is provided by way of illustration only and should not be construed as limiting. Various modifications and substitutions of the described components and operations can be made by those skilled in the art without departing from the spirit and scope of the present invention defined in the following claims, the scope of which is to be accorded the broadest interpretation so as to encompass such modifications and equivalent structures. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, a “memory stick”, optical media, magneto-optical media, CD-ROM, etc.

What is claimed is:

1. A computer-based system for augmenting a work-flow model to handle exceptions, comprising:
an Exception Handling Knowledge Base having respective work-flow transactions for the exceptions;
a Work-flow Manager coupled to the Exception Handling Knowledge Base for automatically adding the exception transactions to the model and managing the execution of the model; and
a Work-flow Monitor for monitoring the execution of the model and generating alerts about the exceptions.

2. The system of claim 1, further comprising a Process Schema Repository coupled to the Work-flow Manager and wherein at build-time the system allows an analyst to specify a work-flow schema and store the schema in the Process Schema Repository.

3. The system of claim 2, wherein at build-time the system allows the analyst to modify the work-flow schema to handle an exception based on information in the Exception Handling Knowledge Base.

4. The system of claim 1, wherein at build-time the system allows an analyst to specify a forbidden exception transition and the forbidden exception transition is not automatically added to the model by the Work-flow Manager.

5. The system of claim 1, wherein at run-time the Work-flow Manager manages a plurality of work-flow instances in the system and allows a user to interact with the work-flow instances.

6. The system of claim 2, wherein at run-time the system has a normal operation mode, an exception operation mode and a requested exception mode, the normal mode allowing only the transitions explicitly defined in the Process Schema Repository, the exception mode allowing any transitions except those forbidden in the Exception Handling Knowledge Base, and the requested exception mode allowing a forbidden transition to be manually executed.

7. The system of claim 6, wherein the transitions in the normal mode are automatically executed by the Work-flow Manager.

8. The system of claim 6, wherein the transitions in the exception mode are initiated by a user.

9. The system of claim 6, wherein in the requested exception mode, a user requests approval from a business manager to execute the forbidden exception transition and the forbidden exception transition is executed if the approval is given.

10. The system of claim 1, wherein the system further comprises an Execution Log Repository, and the Work-flow Monitor generates and stores an exception execution log in the Execution Log Repository when an exception transition is executed.

11. The system of claim 1, wherein the Work-flow Monitor gathers statistics on the exception transitions and the statistics are used for normalizing the exception transitions that occur frequently.

12. The system of claim 11, wherein the statistics are used for normalizing the exception transitions that represent important events in the work-flow model.

13. The system of claim 1, wherein the Exception Handling Knowledge Manager alerts a process analyst when it detects a forbidden exception transition that has frequently been initiated by users.

14. The system of claim 13, wherein the frequently-initiated forbidden exception transition corresponds to a set of rules in the Exception Handling Knowledge Base and the analyst enables the frequently-initiated forbidden exception transition by having the rules executed automatically.

15. The system of claim 14, wherein the rules are in the ECA format.

16. The system of claim 1, further comprising an Exception Handling Knowledge Manager for generating a report on the exception transitions in the work-flow model.

17. A computer-implemented method for augmenting a work-flow model to handle exception transitions, comprising:
generating the work-flow model using a traditional process modeling tool, the model having a plurality of normal transitions each having a source state and a target state;
automatically adding the exception transitions to the model, each exception transition corresponding to a pair of source and target states that were not connected during the model generation;
monitoring the execution of the model to detect the exception transitions; and
generating alerts about the exception transitions.

18. The method of claim 17, further comprising specifying a forbidden exception transition wherein the forbidden exception transition is not automatically added to the model.

20. The method of claim 17, further comprising:
executing, in a normal mode, only the exception transitions that are explicitly defined by an analyst;
executing, in an exception mode, any exception transitions except those forbidden by the analyst; and
executing, in a requested exception mode, any forbidden exception transitions if requested by a user and approved by a business manager.

21. The method of claim 20, wherein the exception transitions in the normal mode are executed automatically and the exception transitions in the exception mode are initiated by a user.

22. A computer program product for use with a computer to augment a work-flow model with exception transitions, the product comprising a computer usable storage medium having program code embodied in the storage medium, said code operable to:
generate the work-flow model using a traditional process modeling tool, the model having a plurality of normal transitions each having a source state and a target state;
automatically add the exception transitions to the model, each exception transition corresponding to a pair of source and target states that were not connected during the model generation; and
generate alerts about the exception transitions.

23. The computer program product of claim 22, further comprising code operable to specify a forbidden work-flow transition wherein the forbidden transition is not automatically added to the model.

24. The computer program product of claim 22, further comprising code operable to:
execute, in a normal mode, only the exception transitions that are explicitly defined by a user;
execute, in an exception mode, any exception transitions except those forbidden by the user; and
execute, in a requested exception mode, any forbidden exception transitions if requested by a user and approved by a business manager.
